(19) United States
(12) Patent Application Publication
(10) Pub. No.: US 2015/0302153 A1
(43) Pub. Date: Oct. 22, 2015

(54) REVERSE DOCUMENT QUALITY REVIEW

(71) Applicant: CERNER INNOVATION, INC., KANSAS CITY, KS (US)

(72) Inventors: KANAKASABHA KAILASAM, OLATHE, KS (US); BETH MCCAULEY, STILWELL, KS (US); CANDACE HALL, KANSAS CITY, MO (US); BRIAN DOUGAN, RAYMORE, MO (US)

(73) Assignee: CERNER INNOVATION, INC., KANSAS CITY, KS (US)

(21) Appl. No.: 14/258,755

(22) Filed: Apr. 22, 2014

(51) Int. Cl. G06F 19/00

(52) U.S. Cl. CPC G06F 19/328; G06F 19/3443

(57) ABSTRACT

Computerized systems and methods identify diagnoses that impact payments to hospitals and verify whether the diagnoses are properly supported. When a diagnosis is identified that impacts payment for services rendered to a patient, patient data for the patient is analyzed to determine if clinical indicators are present to support the diagnosis. If the diagnosis is not supported by the necessary clinical indicators, a notice is sent to a clinician that indicates a diagnosis that impacts payment is not supported, allowing the clinician to supplement the patient data to support the diagnosis.

### BACKGROUND

Under the Medicare program, inpatient medical services are bundled into a number of Diagnosis Related Groups. Hospitals are reimbursed for medical services rendered to patients on per-case flat rate based on the DRG identified for each case. There is a select group of diagnoses that have the potential to impact the DRG used to determine the payment to a hospital. Claims submitted by a hospital for payment may be audited (RAC Audits). The audits may focus on the diagnoses that impact the DRG payment to determine if the patient data submitted supports the diagnoses. If it is found that a diagnosis is not supported, the diagnosis can be removed from the claim, which could potentially reduce the DRG payment and the hospital would have to pay back the difference.

### BRIEF SUMMARY

Embodiments of the present invention relate to assisting hospitals in identifying diagnoses that impact payments for rendered services and ensuring the diagnoses are supported. When a diagnosis that impacts payments for treatment services provided to a patient is identified in patient data, clinical indicators required to support the diagnosis are identified. Patient data for the patient is analyzed to determine whether the clinical indicators required to support the diagnosis are present. If the diagnosis is not properly supported, a notice is provided to a clinician to allow the clinician an opportunity to supplement the patient data in order to support the diagnosis.

Accordingly, in one aspect, an embodiment of the present invention is directed to one or more computer storage media storing computer-useable instructions that, when used by one or more computing devices, cause the one or more computing devices to perform operations. The operations include identifying a diagnosis in patient data for a patient that impacts payment for medical services rendered for the patient. The operations also include determining one or more clinical indicators required to support the diagnosis. The operations further include determining that the patient data does not include at least one of the one or more clinical indicators required to support the diagnosis. The operations still further include providing a notice to a clinician that the patient data for the patient does not include at least one of the one or more clinical indicators required to support the diagnosis.

In another embodiment, an aspect is directed to a method in a clinical computing environment. The method includes accessing, by a first computing process, patient data for a patient. The method also includes identifying, by a second computing process, a diagnosis in the patient data that impacts reimbursement for medical services previously rendered for the patient. The method further includes determining, by a third computing process, a plurality of clinical indicators required to support the diagnosis. The method also includes determining, by a fourth computing process, if the patient data includes the plurality of clinical indicators required to support the diagnosis. If the patient data includes the plurality of clinical indicators required to support the diagnosis, the method includes submitting, by a fifth computing process, billing data that includes the diagnosis and data for the plurality of clinical indicators required to support the diagnosis. If the patient data does not include at least one of the plurality of clinical indicators required to support the diagnosis, the method includes providing, by a sixth computing process, a notice to a clinician that the patient data for the patient does not include at least one of the plurality of clinical indicators required to support the diagnosis. The first, second, third, fourth, fifth, and sixth computing processes are performed by one or more computing devices.

A further embodiment is directed to a system comprising one or more processors; and one or more computer storage media storing instructions that, when used by the one or more processors, cause the one or more processors to: identify a diagnosis in patient data for a patient that impacts payment for medical services rendered for the patient, determine that the patient data does not include at least one clinical indicator required to support the diagnosis, and provide a notice to a clinician that the patient data for the patient does not include at least one clinical indicator required to support the diagnosis.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE SEVERAL VIEWS OF THE DRAWINGS

The present invention is described in detail below with reference to the attached drawing figures, wherein:

FIG. 1 is a block diagram of an exemplary computing environment suitable for use in implementing the present invention;

FIG. 2 is a block diagram of an exemplary system architecture in which embodiments of the invention may be employed; and

FIG. 3 is a flow diagram showing a method for analyzing patient data for diagnoses that impact payments for rendered services and determining whether clinical indicators required to support the diagnoses are present in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different components of methods employed, the terms should not be interpreted as implying any particular order among or between various steps herein disclosed unless and except when the order of individual steps is explicitly described.

Embodiments of the present invention provide computerized methods and systems that may be employed by hospitals to assist in billing for inpatient services rendered to patients in which payments are based at least in part on diagnoses. This may include, for instance, DRG-based payments made by the Centers for Medicare and Medicaid Services (CMS). In particular, the computerized methods and systems identify diagnoses that impact payments for rendered services and determine whether clinical indicators required to support the diagnoses are satisfied. As used herein, the term “clinical indicator” refers to any measure, observation, medical order, treatment plan, or other piece of patient data that may be used to determine the accuracy of a diagnosis for a patient.

In accordance with embodiments of the present invention, patient data may be analyzed to identify a diagnosis that impacts payment for medical services rendered for a patient. For instance, the diagnosis may be one that impacts the DRG rate paid to a hospital. Identification of such a diagnosis may be done in some embodiments when billing data is being collected to submit a payment claim to a payment provider, such as the CMS. In other embodiments, identification of such a diagnosis may be done at an earlier time.

When a diagnosis is identified that impacts payment for medical services rendered for a patient, patient data is analyzed to determine if it contains the clinical indicators required to support the diagnosis. If the required clinical indicators are present, a claim may be submitted. Alternatively, if the required clinical indicators are not present, a notice may be provided to a clinician that a diagnosis is not supported. This may prompt the collection of additional data to ensure that the clinical operators required to support the diagnosis are present.

As a specific example to illustrate an embodiment of the present invention, suppose a patient is admitted to a hospital with coronary artery disease. The doctor indicates in his progress notes that the patient has acute systolic congestive heart failure. The patient is noted to have shortness of breath and history of cardiomyopathy. Laboratory work indicates the BNP is 75. The physician is restricting the patient's fluids and has ordered monitoring input and output. Acute systolic congestive heart failure has also been added as a diagnosis to the discharge summary by the physician.

If acute systolic congestive heart failure was coded and added to the claim being submitted to CMS for payment, the diagnosis would be a counted as a Major Complication/Comorbidity and increase the DRG payment. In accordance with an embodiment of the present invention, the system would identify that the acute systolic congestive heart failure diagnosis is one that impacts payment for the services rendered to the patient. Additionally, the system would analyze the patient data for the patient to determine if clinical indicators for the diagnosis are supported. In the present example, the system would alert a Clinical Documentation Improvement (CDI) specialist and/or the physician that there are not enough clinical indicators to justify this diagnosis due to the fact that the BNP is not elevated and the patient is not being treated with a diuretic. The physician would need to add documentation to justify the diagnosis or modify the diagnosis to coincide with the clinical indicators.

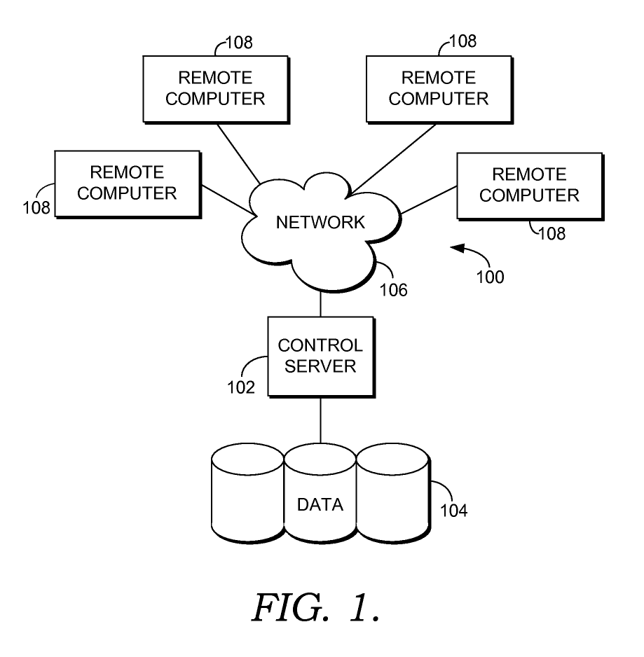

Referring to the drawings in general, and initially to FIG. 1 in particular, an exemplary computing system environment, for instance, a medical information computing system, on which embodiments of the present invention may be implemented is illustrated and designated generally as reference numeral 100. It will be understood and appreciated by those of ordinary skill in the art that the illustrated medical information computing system environment 100 is merely an example of one suitable computing environment and is not intended to suggest any limitation as to the scope of use or functionality of the invention. Neither should the medical information computing system environment 100 be interpreted as having any dependency or requirement relating to any single component or combination of components illustrated therein.

The present invention may be operational with numerous other general purpose or special purpose computing system environments or configurations. Examples of well-known computing systems, environments, and/or configurations that may be suitable for use with the present invention include, by way of example only, personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention may be described in the general context of computer-executable instructions, such as program modules, being executed by a computer. Generally, program modules include, but are not limited to, routines, programs, objects, components, and data structures that perform particular tasks or implement particular abstract data types. The present invention may also be practiced in distributed computing environments where tasks are performed by remote processing devices that are linked through a communications network. In a distributed computing environment, program modules may be located in local and/or remote computer storage media including, by way of example only, memory storage devices.

With continued reference to FIG. 1, the exemplary medical information computing system environment 100 includes a general purpose computing device in the form of a server 102. Components of the server 102 may include, without limitation, a processing unit, internal system memory, and a suitable system bus for coupling various system components, including database cluster 104, with the server 102. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server 102 typically includes, or has access to, a variety of computer readable media, for instance, database cluster 104. Computer readable media can be any available media that may be accessed by server 102, and includes volatile and nonvolatile media, as well as removable and non-removable media. By way of example, and not limitation, computer readable media may include computer storage media and communication media. Computer storage media may include, without limitation, volatile and nonvolatile media, as well as removable and nonremovable media implemented in any method or technology for storage of information, such as computer readable instructions, data structures, program modules, or other data. In this regard, computer storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the server 102. Computer storage media does not comprise signals per se. Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer readable media.

The computer storage media discussed above and illustrated in FIG. 1, including database cluster 104, provide storage of computer readable instructions, data structures, program modules, and other data for the server 102.

The server 102 may operate in a computer network 106 using logical connections to one or more remote computers 108. Remote computers 108 may be located at a variety of locations in a medical or research environment, for example, but not limited to, clinical laboratories, hospitals and other inpatient settings, veterinary environments, ambulatory settings, medical billing and financial offices, hospital administration settings, home health care environments, and clinicians' offices. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, genetic counselors, researchers, veterinarians, students, and the like. The remote computers 108 may also be physically located in non-traditional medical care environments so that the entire health care community may be capable of integration on the network. The remote computers 108 may be personal computers, servers, routers, network PCs, peer devices, other common network nodes, or the like, and may include some or all of the components described above in relation to the server 102. The devices can be personal digital assistants or other like devices.

Exemplary computer networks 106 may include, without limitation, local area networks (LANs) and/or wide area networks (WANs). Such networking environments are commonplace in offices, enterprise-wide computer networks, intranets, and the Internet. When utilized in a WAN networking environment, the server 102 may include a modem or other means for establishing communications over the WAN, such as the Internet. In a networked environment, program modules or portions thereof may be stored in the server 102, in the database cluster 104, or on any of the remote computers 108. For example, and not by way of limitation, various application programs may reside on the memory associated with any one or more of the remote computers 108. It will be appreciated by those of ordinary skill in the art that the network connections shown are exemplary and other means of establishing a communications link between the computers (e.g., server 102 and remote computers 108) may be utilized.

In operation, a user may enter commands and information into the server 102 or convey the commands and information to the server 102 via one or more of the remote computers 108 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the server 102. In addition to a monitor, the server 102 and/or remote computers 108 may include other peripheral output devices, such as speakers and a printer.

Although many other internal components of the server 102 and the remote computers 108 are not shown, those of ordinary skill in the art will appreciate that such components and their interconnection are well known. Accordingly, additional details concerning the internal construction of the server 102 and the remote computers 108 are not further disclosed herein.

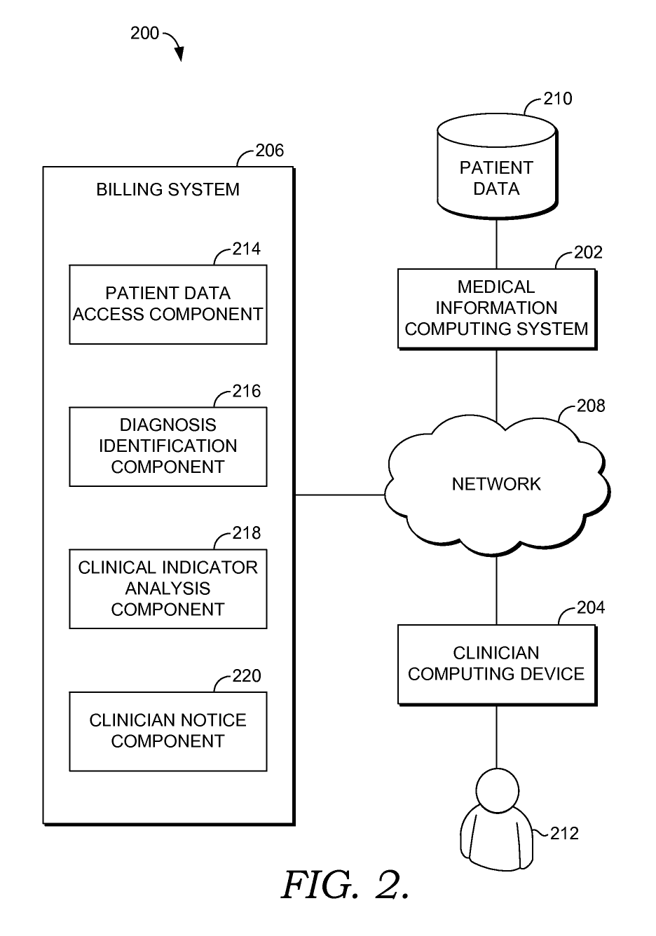

Referring now to FIG. 2, a block diagram is provided illustrating an exemplary system 200 in which a billing system 206 is generally configured to facilitate the process of billing payment providers for services rendered to patients by a hospital and its clinicians. In accordance with embodiments of the present invention, the billing system 206 is configured to recognize when diagnoses that impacts payment for services rendered to patients are not supported by clinical indicators and to facilitate the collection of data to support the diagnoses.

The billing system 206 may be a stand-alone system interfaced with a medical information computing system 202 via a network 208 in accordance with one embodiment of the present invention, as shown in FIG. 2. The medical information computing system 202 may be a comprehensive computing system within a clinical environment similar to the exemplary computing system 100 discussed above with reference to FIG. 1. Although the billing system 206 is shown separate from the medical information computing system 202 in FIG. 2, in some embodiments, the billing system 206 may be a subsystem of the medical information computing system 202. Any and all such variations are contemplated to be within the scope of embodiments of the present invention.

As shown in FIG. 2, the billing system 206 includes a patient data access component 214, diagnosis identification component 216, clinical indicator analysis component 218, and a clinician notice component 220. The patient data access component 214 may generally be configured to access patient data 210 maintained by the medical information computing system 202 for billing purposes discussed herein.

The diagnosis identification component 216 operates to identify diagnoses in patient data that will impact payments for services rendered to patients. In some embodiments, the billing system 206 may maintain a list of diagnoses that impact payments. For instance, the list of diagnoses may include diagnoses that impact the DRG for a case. The diagnosis identification component 216 may employ the list of diagnoses to identify patient data that includes any of the listed diagnoses.

The diagnosis identification component 216 may identify diagnoses that impact payments in patient data at a variety of different points in time in various embodiments of the present invention. In some embodiments, the diagnosis identification component 216 may identify a diagnosis that impacts payment when a claim is being prepared for submission to a payment provider, such as the CMS. In other embodiments, the identification may occur at an earlier point in time. For instance, the diagnosis identification component 216 in some embodiments may identify a diagnosis that impacts payment at the time the diagnosis is entered into patient data for a patient. In other embodiments, the diagnosis identification component 216 may be configured to periodically (e.g., daily) scan patient data to identify diagnoses that impact payments. Any and all such variations are contemplated to be within the scope of embodiments of the present invention.

When the diagnosis identification component 216 identifies a diagnosis for a patient that impacts payment for services rendered to that patient, the clinical indicator analysis component 218 is configured to analyze patient data available for the patient to determine whether the patient data includes the clinical indicators necessary to support the diagnosis. In some embodiments, the billing system 206 may maintain information regarding the clinical indicators required to support each diagnosis that impacts payments. For some diagnoses, this may include a single clinical indicator. For other diagnoses, this may include multiple clinical indicators. Accordingly, the clinical indicator analysis component 218 may be configured to search the patient data for the patient to determine if the patient data contains the clinical indicators required for the diagnosis identified for the patient that impacts payment for the services rendered for the patient.

The clinician notice component 220 is configured to provide a notice to a clinician if the clinical indicator analysis component 218 determines that patient data for a patient does not include all the clinical indicators for a diagnosis that impacts payment. For instance, the clinician notice component 220 may deliver a notice to a clinician computing device, such as the clinician computing device 204 operated by the clinician 212. The notice may be provided to one or more clinicians. In some instances, the notice may be provided to a clinician treating the patient. In some instances, a hospital may have a Clinical Documentation Improvement (CDI) specialist who is responsible for ensuring that claims being submitted to a payment provider have the necessary documentation. The notice could be provided to the CDI specialist who may work with a treating physician to collect patient data to provide the missing clinical indicators. In some embodiments, a clinician may be selected to receive the notice based on the type of clinical indicator missing. For instance, if data for a particular clinical indicator is usually provided by a particular type of clinician, the notice may be provided to that type of clinician.

The notice may be provided to the clinician computing device 204 using any electronic communication approaches, such as, for instance, an email, a text message, or a voice message to name a few. In some embodiments, the clinician computing device 204 may provide a user interface component (not shown) that is responsible for providing a notice that patient data does not include all clinical operators required for a diagnosis. For instance, the clinician computing device 204 may provide a queue of diagnoses identified as not being supported by patient data. This queue may provide a clinician, such as a CDI specialist, with a location to manage cases in which a diagnosis is not supported by the patient data. For instance, a CDI specialist may be tasked with following up with other clinicians to collect patient data for missing clinical indicators.

The notice provided by the clinician notice component 220 may provide a range of different information and options. In some embodiments, the notice may simply indicate that a diagnosis that impacts payment was identified and that all clinical indicators required to support the diagnosis have not been found in available patient data. In other embodiments, the notice may identify which clinical indicators are missing from the patient data. In some embodiments, the notice may identify clinical indicators that were found in the patient data. In further embodiments, the notice may identify particular data that is needed to satisfy the missing clinical indicators or other actions that may be taken to collect the needed data. In some embodiments, the notice may provide links to perform actions (e.g., submit orders for tests) to collect needed data. Accordingly, the notice may prompt a clinician to perform additional actions to collect data needed to show clinical indicators required to support a diagnosis are present.

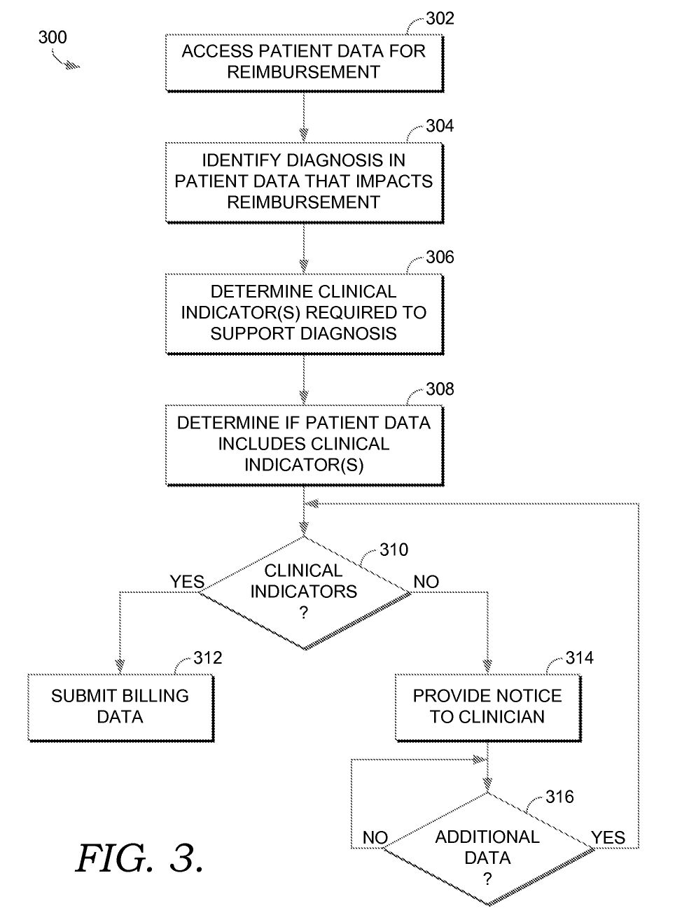

Turning to FIG. 3, a flow diagram is provided that illustrates a method 300 for analyzing patient data for diagnoses that impact payments for rendered services and determining whether clinical indicators required to support the diagnoses are present in accordance with an embodiment of the present invention. As shown at block 302, patient data is accessed. The patient data is analyzed to identify a diagnosis in the patient data that impacts payment for the services rendered to the patient, as shown at block 304. For instance, the system may store a list of diagnoses that impact payments. This may include, for instance, diagnoses that fall into different DRGs for Medicare payments. As such, the system may determine the patient data includes one of the listed diagnoses.

One or more clinical indicators required to support the diagnosis identified in the patient data are determined, as shown at block 306. For instance, the system may store information regarding clinical indicators required to support each diagnosis that impacts payment for rendered services. For some diagnoses, only a single clinical indicator may be required, but for other diagnoses, multiple clinical indicators may be required. Accordingly, the system may use this information to look up what clinical indicators are required to support the diagnosis identified in the patient data.

A determination is made at block 308 regarding whether the patient data available for the patient includes the clinical indicators required to support the identified diagnosis. If it is determined at block 310 that the patient data includes the required clinical indicators, billing data is submitted to a payment provider, as shown at block 312.

Alternatively, if it is determined at block 310 that the patient data does not include all the required clinical indicators, a notice is provided to a clinician, as shown at block 314. The notice may be provided to any number of clinicians and any of a variety of different types of clinicians. In some instances, the notice may be provided to a CDI specialist who is responsible for ensuring that claims being submitted to a payment provider have the necessary documentation. In some instances, the notice may be provided to one or more physicians who are responsible for treating the patient. In some embodiments, the notice may be delivered to a particular clinician or type of clinician based on a type of clinical indicator that is missing. For instance, if a particular clinician or type of clinician is responsible for ordering, collecting, or otherwise providing the information required for a clinical indicator that is missing from the patient data, that particular clinician or type of clinician may be selected to receive the notice.

The notice may be provided to a clinician in any of a variety of different manners within the scope of embodiments of the present invention. By way of example only and not limitation, the notice may be delivered to a clinician via an email, a text message, or a voice message, to name a few. In some embodiments, the notice may be provided in a user interface that is used to manage cases identified as having a diagnosis that impacts payments in which all clinical indicators required to support the diagnosis are not found.

The notice may provide a variety of different information in various embodiments of the present invention. In some embodiments, the notice may simply indicate that the clinical indicators required to support the diagnosis have not been satisfied. In other embodiments, the process may include determining which clinical indicators have not been satisfied by the patient data, and the notice may provide an indication identifying those missing clinical indicators. In further embodiments, the notice may provide additional information, such as what specific data (e.g., data from a particular lab result) or what orders are needed to obtain information for a missing clinical indicator. In further embodiments, a link may be provided to a user interface that allows the clinician to perform actions (such as submitting an order for a particular test) to obtain the information for a missing clinical indicator. In some embodiments, the notice may indicate clinical indicators that have been found in the patient data.

After the notice is sent to a clinician, the system monitors whether additional data is received for the patient, as shown at block 316. As shown in FIG. 3, the system may periodically or continuously check to see if new data is received until new patient data is available or some other point in time, such as a time at which the billing information is to be submitted to a payment provider. Alternatively, if new patient data is detected at block 316, the process of determining whether the patient data includes the clinical indicators required to support the diagnosis may be repeated, as shown by the return to block 308.

As can be understood, embodiments of the present invention provide a system that may be employed by a hospital to identify diagnoses that impact payments for rendered services, determine if required clinical indicators are found, and to prompt clinicians for additional data if clinical indicators are missing. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated and within the scope of the claims.

What is claimed is:

1. One or more computer storage media storing computer-useable instructions that, when used by one or more computing devices, cause the one or more computing devices to perform operations comprising:
identifying a diagnosis in patient data for a patient that impacts payment for medical services rendered for the patient;
determining one or more clinical indicators required to support the diagnosis;
determining that the patient data does not include at least one of the one or more clinical indicators required to support the diagnosis; and
providing a notice to a clinician that the patient data for the patient does not include at least one of the one or more clinical indicators required to support the diagnosis.

2. The one or more computer storage media of claim 1, wherein the payment for the medical services rendered for the patient is based on a diagnosis-related group (DRG) payment system.

3. The one or more computer storage media of claim 2, wherein the diagnosis affects classification into a DRG used to determine the payment for the medical services rendered for the patient.

4. The one or more computer storage media of claim 1, wherein a plurality of clinical indicators are required to support the diagnosis.

5. The one or more computer storage media of claim 4, wherein determining that the patient data does not include at least one of the one or more clinical indicators required to support the diagnosis comprises determining that the patient data does not include a first clinical indicator from the plurality of clinical indicators.

6. The one or more computer storage media of claim 5, wherein the notice to the clinician indicates that the patient data does not include the first clinical indicator.

7. The one or more computer storage media of claim 6, wherein the operations further comprise:
receiving data for the first clinical indicator; and
submitting billing data that includes the diagnosis and data for the plurality of clinical indicators required to support the diagnosis.

8. The one or more computer storage media of claim 6, wherein the notice to the clinician indicates a clinical action required to obtain data for the first clinical indicator.

9. The one or more computer storage media of claim 7, wherein the operations further comprise providing a link to access a user interface to place a clinical order for the clinical action to obtain data for the first clinical indicator.

10. The one or more computer storage media of claim 6, wherein the operations further include determining that the patient data includes a second clinical indicator from the plurality of clinical operators, and wherein the notice indicates that the patient data includes the second clinical indicator.

11. A method in a clinical computing environment comprising:
accessing, by a first computing process, patient data for a patient;
identifying, by a second computing process, a diagnosis in the patient data that impacts reimbursement for medical services previously rendered for the patient;
determining, by a third computing process, a plurality of clinical indicators required to support the diagnosis;
determining, by a fourth computing process, if the patient data includes the plurality of clinical indicators required to support the diagnosis;
if the patient data includes the plurality of clinical indicators required to support the diagnosis, submitting, by a fifth computing process, billing data that includes the diagnosis and data for the plurality of clinical indicators required to support the diagnosis; and
if the patient data does not include at least one of the plurality of clinical indicators required to support the diagnosis, providing, by a sixth computing process, a notice to a clinician that the patient data for the patient does not include at least one of the plurality of clinical indicators required to support the diagnosis;
wherein the first, second, third, fourth, fifth, and sixth computing processes are performed by one or more computing devices.

12. The method of claim 11, wherein the reimbursement for the medical services previously rendered for the patient is based on a diagnosis-related group (DRG) payment system; and wherein the diagnosis affects classification into a DRG used to determine the reimbursement for the medical services previously rendered for the patient.

13. The method of claim 11, wherein if the patient data does not include at least one of the plurality of clinical indicators required to support the diagnosis, the method further comprises determining the patient data does not include a first clinical indicator from the plurality of clinical indicators.

14. The method of claim 13, wherein the notice to the clinician indicates that the patient data does not include the first clinical indicator.

15. The method of claim 14, wherein if the patient data does not include at least one of the plurality of clinical indicators required to support the diagnosis, the method further comprises:
receiving data for the first clinical indicator; and
submitting billing data that includes the diagnosis and data for the plurality of clinical indicators required to support the diagnosis.

16. The method of claim 14, wherein the notice to the clinician indicates a clinical action required to obtain data for the first clinical indicator.

17. A system comprising:
one or more processors; and
one or more computer storage media storing instructions that, when used by the one or more processors, cause the one or more processors to:
identify a diagnosis in patient data for a patient that impacts payment for medical services rendered for the patient,
determine that the patient data does not include at least one clinical indicator required to support the diagnosis, and
provide a notice to a clinician that the patient data for the patient does not include at least one clinical indicator required to support the diagnosis.

18. The system of claim 17, wherein the payment for the medical services rendered for the patient is based on a diagnosis-related group (DRG) payment system; and
wherein the diagnosis affects classification into a DRG used to determine the payment for the medical services rendered for the patient.

19. The system of claim 17, wherein a plurality of clinical indicators are required to support the diagnosis, wherein determining that the patient data does not include at least one clinical indicator required to support the diagnosis comprises determining that the patient data does not include a first clinical indicator from the plurality of clinical indicators; and wherein the notice to the clinician indicates that the patient data does not include the first clinical indicator.

20. The system of claim 19, wherein the instructions further cause the one or more processors to:
receive data for the first clinical indicator; and
submit billing data that includes the diagnosis and data for the plurality of clinical indicators required to support the diagnosis.
